(19) United States
(12) Patent Application Publication
(10) Pub. No.: US 2022/0299951 A1
(43) Pub. Date: Sep. 22, 2022

(54) COMPOSITIONAL PROPERTY ESTIMATION MODELS RELATING TO PROCESSES AND RELATED METHODS

(71) Applicant: ExxonMobil Research and Engineering Company, Annanadale, NJ (US)

(72) Inventors: Jitendra V. KADAM, Kingwood, TX (US); George A. KHOURY, Beaumont, TX (US); Clayton R. CARR, Houston, TX (US); Trevor S. POTTORF, Tomball, TX (US); Onur ONEL, Houston, TX (US); Victoria G. YAO, College Station, TX (US)

(73) Assignee: ExxonMobil Research and Engineering Company, Annanadale, NJ (US)

(21) Appl. No.: 17/697,167

(22) Filed: Mar. 17, 2022

Related U.S. Application Data
(60) Provisional application No. 63/163,374, filed on Mar. 19, 2021.

(51) Int. Cl. G05B 13/04; G05B 13/02; G06K 9/62

(52) U.S. Cl. CPC G05B 13/042; G05B 13/0265; G06K 9/6232

(57) ABSTRACT

Methods for building models that estimate compositional properties of a process may include (a) receiving data relating to a process; (b) cleaning the data by identifying and removing outlying data points from the data; and conditioning the data; (c) identifying inferential model parameters comprising a parameter selected from the group consisting of: a compositional property of the process as a model output that is not part of the data, operational constraints of the process, interactions between process variables of the chemical process, and any combination thereof; (d) building one or more inferential models based on the cleaned data and the inferential model parameters; and (e) outputting the one or more models and the corresponding validation metric.

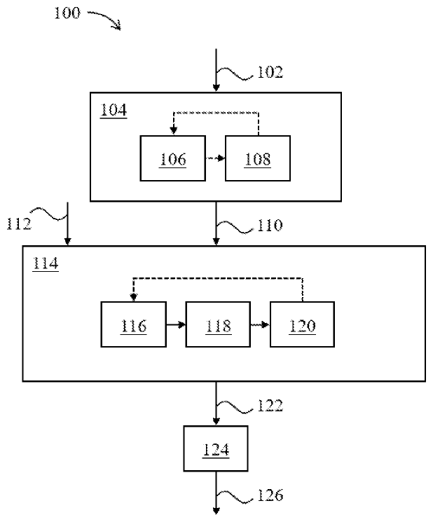

### FIELD OF INVENTION

This application relates to methods and systems for building models that estimate compositional properties of a process, such as a refining and/or a petrochemical process.

### BACKGROUND

Manufacturing processes, such as refining processes and/or chemical manufacturing processes, are dynamic where the composition or properties of said composition at each stage depends on several variables. While some conditions of the process are easy to measure in real-time, like temperature and pressure, often, the composition or properties of said composition are difficult to measure in real-time. Examples of some properties include flash point, boiling point, melt flow index, and the like. Preferably, during the process, process parameters would be changed in real-time to achieve the desired composition or properties of said composition. However, when the composition or properties of said composition are difficult or impossible to measure in real-time, manufacturers rely on experience to adjust process parameter.

### SUMMARY OF INVENTION

This application relates to methods and systems for building models that estimate compositional properties of a refining and/or chemical manufacturing process.

A method described herein may comprise: (a) receiving data relating to a process; (b) cleaning the data to produce cleaned data, wherein cleaning the data comprises: identifying and removing outlying data points from the data; and conditioning the data; (c) identifying inferential model parameters comprising a parameter selected from the group consisting of: a compositional property of the process as a model output that is not part of the data, operational constraints of the process, interactions between process variables of the process, and any combination thereof; (d) building one or more inferential models based on the cleaned data and the inferential model parameters, wherein building comprises: identifying input variables from the cleaned data; fitting the input variables from a first portion of the cleaned data to a model; validating the model using a second portion of the cleaned data to yield a validation metric corresponding to the model; and (e) outputting the one or more models and the corresponding validation metric.

A system described herein may comprise: a processor; a memory coupled to the processor; and instructions provided to the memory, wherein the instructions are executable by the processor to perform the foregoing method.

### BRIEF DESCRIPTION OF THE DRAWINGS

The following FIGURE is included to illustrate certain aspects of the disclosure, and should not be viewed as an exclusive configuration. The subject matter disclosed is capable of considerable modifications, alterations, combinations, and equivalents in form and function, as will occur to those skilled in the art and having the benefit of this disclosure.

The FIGURE illustrates a nonlimiting example method of the present disclosure for building a model that estimates a compositional property within a portion of a manufacturing process.

### DETAILED DESCRIPTION

This application relates to methods and systems for building models that estimate compositional properties of a process. The application further relates to the application of said models in refining and/or chemical processes. Said processes may relate to the production, refining, manufacture, formulation, blending, and/or storage of chemicals (e.g., fuels such as gasoline, diesel, biofuels, and kerosene; commodity and specialty chemicals such as olefins, aromatics, monomers, polymers, surfactants, dyes and pigments, and fertilizers; catalysts; lubricants; and the like).

Generally, the methods and systems described herein may build models that may be implemented in real-time to provide estimations for compositional properties (e.g., flash point, melting point, freezing point, and the like) that are not easily measured in real-time. Implementation of said models may allow for operators to make real-time changes to the process in order to change the compositional property being estimated. This may improve efficiency and/or efficacy of the process and, thereby, reduce manufacturing costs.

Further, the methods and systems described herein may build models that are less complex and require less computing power because the number of variables on which the models depend can be reduced.

The FIGURE illustrates a nonlimiting example method 100 of the present disclosure. Data 102 relating to a process is cleaned 104 to yield cleaned data 110. The cleaning includes identifying and removing 106 outlying data points (e.g., individual data points or a range of data points) from the data 102 and conditioning 108 the data 102. These two aspects of cleaning 104 may be performed in either order and, optionally, iteratively, which is illustrated with the dashed lines.

The data 102 may include data from upstream of the process being considered, downstream of the process being considered, directly from the process being considered, or a combination thereof. For example, in a distillation process where the amount of component X in a bottoms fraction is of interest, upstream data like the temperature gradient along the column and the composition of the feedstock may be relevant, and process data like temperature of the bottoms stream may be relevant. In yet another example, downstream data may be relevant to recycle streams in a distillation column system.

Examples of data 102 relating to a process may include, but is not limited to, temperature, pressure, pressure compensated temperature, chemical species concentration, feed quality, contaminant concentrations, bed height (e.g., in polymer synthesis), density, specific gravity, API gravity, draw rate, feed rate, flow rate, space velocity, and the like, and any combination thereof. The data 102 may come from direct measurements, process analyzers, calculations using measured values (e.g., ratios, differences, and the like), and the like.

Examples of methods for identifying and removing 106 outlying data points from the data 102 may include, but is not limited to, slicing methods, conditional methods, statistical methods, and the like, and any combination thereof for identifying said outlying data points that are then removed from the data 102. Examples of conditional methods may include, but is not limited to, if/then statements, if and only if statements, and the like, and any combination thereof. Examples of statistical methods may include, but is not limited to, standard deviation, least absolute deviations, Z-score, interquartile range method, mean filtering, Gaussian processes, Fast Fourier Transform (FFT) methods, Markov chain Monte Carlo (McMC) methods, overall basis methods, rolling basis methods, and the like, and any combination thereof.

Conditioning 108 the data 102 aims to apply a dynamic compensation to the data 102, which may include synchronizing variables, noise filtering, and the like, and any combination thereof. In many chemical processes, there may be a time lag between an event occurring and an analyzer measurement. For example, holding tanks or lines may be located between the process being considered and the actual analyzer. Therefore, the measurement may be from a sample taken or isolated several minutes previous. Alternatively, the process of a specific measurement may take time to complete. In either instance, the data from said analyzer may be time shifted to synchronize said measurement with other measurements that may be at or near instantaneous measurements. For example, a sample measurement via gas or liquid chromatography may take time to procure, while a temperature and/or pressure measurement may be at to near instantaneous. Conditioning 108 the data 102 may include manipulating the time stamp of the chromatography data to synchronize the chromatography measurement with the temperature and/or pressure measurement.

Examples of methods of conditioning 108 the data 102 may include, but is not limited to, transformation methods (e.g., one variable calculations), calculation methods (e.g., two variable calculations), interpolation methods (e.g., fixing segments of data), filtering methods, smoothing methods, and the like, and any combination thereof. Examples of transformation methods may include, but is not limited to, ln(a), e^{b}, and the like, and any combination thereof. Examples of calculation methods may include, but is not limited to, a+b, b*a, and the like, and any combination thereof. Examples of interpolation methods may include, but is not limited to, fixing a gap in the data, deleting data containing errors, and the like, and any combination thereof. Examples of filtering methods may include, but is not limited to, Kalman filtering, Kolmogorov-Zurbenko filtering, and the like, and any combination thereof. Examples of smoothing methods may include, but are not limited to, additive smoothing, exponential smoothing, Kernal smoothing, moving average smoothing, and the like, and any combination thereof.

Different data sets from the data 102 may use different methods for identifying and removing 106 outliers and conditioning 108. Preferably, the individual cleaning 104 methods are straightforward methods so that the cleaning 104 step does not slow the model. A user may select parameters that limit the cleaning 104. For example, when smoothing, a user may select a time scale or number of data points for a moving average smoothing. Additionally or alternatively, a user may set a value for diminishing returns that stops the granularity of conditioning 108 based on the amount of change in the data 102 with additional iterations for improved conditioning 108. In another example, a user may remove data points based on statistics and/or user defined thresholds.

Referring again to the FIGURE, the cleaned data 110 along with inferential model parameters 112 are used for building 114 inferential models 122. The building 114 process includes three steps that may be performed iteratively. The building 114 process may produce one or more inferential models 122 from which a user may choose.

The building process includes selecting 116 the variables from the cleaned data 110 to be used in the model, fitting 118 the cleaned data 110 to a model, and validating 120 the model. The inferential model parameters 112 are used to limit the building 114 process. The inferential model parameters 112 may include, but are not limited to, a compositional property of the process as a model output that is not part of the data, operational constraints of the process, interactions between process variables of the process, building iterations, model to use in building 114, and the like, and any combination thereof. Preferably, the inferential model parameters 112 include, at least, a compositional property of the chemical process as a model output that is not part of the data, operational constraints of the chemical process, and interactions between process variables of the process.

Examples of a compositional property of the process as a model output may include, but is not limited to, concentration of a component in the composition, flash point, freezing point, boiling point, cloud point, melt flow index, density, and the like, and any combination thereof.

Examples of operational parameters that may be associated with constraints of the process may include, but are not limited to, temperature, pressure, chemical species concentration, flow rate, temperature set points (e.g., T95 and/T5) for distillation fractions, and the like, and any combination thereof. Each operational constraints may independently be, for example, threshold values (e.g., a maximum temperature of 100° C.), a range of values (e.g., a temperature of 50° C. to 100° C.), a value optionally including an allowable variability (e.g., a temperature of 75° C.±5° C.), and the like.

Examples of interactions between process variables of the process include, but are not limited to, reaction rates, heat balance, correlations between temperature and pressure, operational parameter deltas (e.g., temperature differences, pressure differences, and the like), operational parameter ratios, and the like, and any combination thereof.

Building iterations may be a set number of iterations to be performed. Alternatively, building iterations may be a value for diminishing returns that stops the granularity of building 114 based on the amount of change in the validating 120 results. Further, the diminishing returns value may be accompanied by a threshold number of iterations to be performed.

The models that are used in the building 114 (e.g., the model used for fitting 118 the selected variable to) may be based on neural networks, decision trees/random forest methods, kernal methods, reinforcement learning methods, and the like, and any ensemble thereof. Examples of neural networks include, but are not limited to, perception, feed forward, radial basis, deep feed forward, recurrent neural network, long-short term memory, gated recurrent unit, auto encoder, variational auto encoder, denoising auto encoder, sparse auto encoder, Markov chain, Hopfield network, Boltzmann machine, restricted Boltzmann machine, deep belief network, deep convolutional network, deconvolutional network, deep convolutional inverse graphics network, generative adversarial network, liquid state machine, extreme learning machine, echo state network, deep residual network, Kohonen network, support vector machine, neural turning machine, and the like. Examples of kernal methods include, but are not limited to, kernel perceptron, Gaussian processes, principal components analysis, canonical correlation analysis, ridge regression, spectral clustering, linear adaptive filters, and the like.

Inferential model parameters 112 may be defined by the user and/or preset based on the process and the system in which the refining and/or petrochemical process is occurring. Further, inferential model parameters 112 may be suggested based on the process and the system in which the chemical process is occurring, which allows the user to define the inferential model parameters 112 by changing or accepting said suggested values.

Variable selection 116 may be defined by the user, for example, as specific variables to include and/or exclude, a maximum number of variables, and the like, and any combination thereof. For example, the cleaned data 110 may include ten variables. Then, the user may select two variables that must be include, one variable to be excluded, and a maximum number of five variables. The variable selection 116 in the building 114 process may then use these constraints to build 114 one or more inferential models 122. Alternatively, the user may define the five variables to be used and the five variables to be excluded.

Alternatively, the user may opt not to provide any constraints to variable selection 116, and building 114 may include the variable selection 116.

Whether constrained or not, variable selection 116 when performed as a part of the building 114 process may use variable selection methods that may include, but are not limited to, cross correlation matrix methods, relief ranking methods, statistical variable reduction methods, latent variable methods, and the like, and any combination thereof.

Once the variables are selected 116, the cleaned data 110 corresponding to said variables is fit 118 to one or more models. Once fit to a model, the model is validated 120 to determine the accuracy of the model. Generally, fitting 118 the model uses a portion of the cleaned data 110 and validating uses another portion of the cleaned data 110.

Validation methods may include, but are not limited to, cross-validation methods, tradeoff complexity versus accuracy methods, computational time analysis, and the like, and any combination thereof. The validation methods produce validation metrics. Examples of validation metrics include, but are not limited to, average R², look ahead R², average error, standard deviation of error, number of data points, and the like, and any combination thereof.

After validation 120, the model may go through the building process again where different variables are selected to work toward improving the validation metrics.

The output of building is one or more models 122 with corresponding validation metrics. The user may then select 124, based on the validation metrics, the preferred model 126 for implementation. Part of the inferential model parameters 112 may be thresholds for one or more of the validation metrics. Therefore, the output may be a single model and, therefore, the preferred model.

Models built by the methods and systems described herein may relate to a variety of processes including, but not limited to, the production, refining, manufacture, formulation, blending, and/or storage of chemicals (e.g., fuels such as gasoline, diesel, and kerosene; commodity and specialty chemicals such as olefins, aromatics, monomers, polymers, surfactants, dyes and pigments, and fertilizers; catalysts; and the like).

By way of nonlimiting example, a model relating to a distillation process may estimate the amount of butane contamination in the bottoms fraction consisting primarily of pentane. Determination of the amount of butane in such a situation can be a long analysis process. A model built by the methods described herein may allow for estimating, in real-time, the amount of butane in the bottoms fraction.

By way of another nonlimiting example, a model relating to polymer synthesis may estimate a property of the product. For example, an A-B copolymer may be produced using monomer A and comonomer B. A model built by the methods described herein may allow for estimating, in real-time, the amount of comonomer B in the A-B copolymer product and, consequently, estimating the melt flow index of the A-B copolymer product.

In yet another nonlimiting example, methods described herein may be applied to build models relating to the performance of a vacuum distillation tower where the performance may be measured by output volume and/or product purity. A model built by the methods described herein may allow for estimating, in real-time, the performance based on the conditions in the vacuum distillation tower and/or estimating the performance when a condition of the vacuum distillation tower is changed.

“Computer-readable medium” or “non-transitory, computer-readable medium,” as used herein, refers to any non-transitory storage and/or transmission medium that participates in providing instructions to a processor for execution. Such a medium may include, but is not limited to, non-volatile media and volatile media. Non-volatile media includes, for example, NVRAM, or magnetic or optical disks. Volatile media includes dynamic memory, such as main memory. Common forms of computer-readable media include, for example, a floppy disk, a flexible disk, a hard disk, an array of hard disks, a magnetic tape, or any other magnetic medium, magneto-optical medium, a CD-ROM, a holographic medium, any other optical medium, a RAM, a PROM, and EPROM, a FLASH-EPROM, a solid state medium like a memory card, any other memory chip or cartridge, or any other tangible medium from which a computer can read data or instructions. When the computer-readable media is configured as a database, it is to be understood that the database may be any type of database, such as relational, hierarchical, object-oriented, and/or the like. Accordingly, exemplary embodiments of the present systems and methods may be considered to include a tangible storage medium or tangible distribution medium and prior art-recognized equivalents and successor media, in which the software implementations embodying the present techniques are stored.

The methods described herein may, and in many embodiments must, be performed, at least in part, using computing devices or processor-based devices that include a processor; a memory coupled to the processor; and instructions provided to the memory, wherein the instructions are executable by the processor to perform the methods described herein (such as computing or processor-based devices may be referred to generally by the shorthand “computer”). For example, a system may comprise: a processor; a memory coupled to the processor; and instructions provided to the memory, wherein the instructions are executable by the processor to perform the methods described herein.

### Example Embodiments

A first nonlimiting example embodiment is a method comprising: (a) receiving data relating to a process; (b) cleaning the data to yield cleaned, wherein cleaning the data comprises: identifying and removing outlying data points from the data; and conditioning the data; (c) identifying inferential model parameters comprising a parameter selected from the group consisting of: a compositional property of the process as a model output that is not part of the data, operational constraints of the process, interactions between process variables of the process, and any combination thereof; (d) building one or more inferential models based on the cleaned data and the inferential model parameters, wherein building comprises: identifying input variables from the cleaned data; fitting the input variables from a first portion of the cleaned data to a model; validating the model using a second portion of the cleaned data to yield a validation metric corresponding to the model; and (e) outputting the one or more models and the corresponding validation metric.

A second nonlimiting example embodiment is a system comprising: a processor; a memory coupled to the processor; and instructions provided to the memory, wherein the instructions are executable by the processor to perform the method of the first nonlimiting example embodiment.

The first and second nonlimiting example embodiments may further include one or more of: Element 1: the method further comprising: selecting a preferred model from the one or more models based on the corresponding validation metric; Element 2: Element 1 and the method further comprising: implementing the preferred model relative to the process or a related process; Element 3: wherein the one or more models is one model, and wherein the method further comprises: implementing the one model relative to the process or a related process; Element 4: wherein the data is selected from the group consisting of: upstream data, process data, downstream data, and any combination thereof; Element 5: wherein the identifying of the outlying data points comprises a method selected from the group consisting of: slicing methods, conditional methods, statistical methods, and any combination thereof; Element 6: wherein the conditioning of the data comprises a method selected from the group consisting of: synchronizing variables, noise filtering, and the like, and any combination thereof; Element 7: wherein the compositional property is selected from the group consisting of: concentration of a component in the composition, flash point, freezing point, boiling point, cloud point, melt flow index, density, and any combination thereof; Element 8: wherein operational constraints comprise a constraint of an operation parameter selected from the group consisting of: temperature, pressure, pressure compensated temperature, chemical species concentration, feed quality, contaminant concentrations, bed height, density, specific gravity, API gravity, draw rate, feed rate, flow rate, space velocity, and any combination thereof; Element 9: wherein the interactions between process variables comprise an interaction selected from the group consisting of: reaction rates, heat balance, correlations between temperature and pressure, operational parameter deltas, operational parameter ratios, and any combination thereof; Element 10: wherein the input variables comprise a variable selected from the group consisting of: temperature, pressure, pressure compensated temperature, chemical species concentration, feed quality, contaminant concentrations, bed height, density, specific gravity, API gravity, draw rate, feed rate, flow rate, space velocity, and the like, and any combination thereof; Element 11: wherein the identifying the input variables include a method selected from the group consisting of: cross correlation matrix methods, relief ranking methods, statistical variable reduction methods, latent variable methods, and any combination thereof; Element 12: wherein the models are selected from the group consisting of: neural networks, decision trees/random forest methods, kernal methods, reinforcement learning methods, and any ensemble thereof; Element 13: wherein the validation metric comprises a metric selected from the group consisting of: average R², look ahead R², average error, standard deviation of error, number of data points, and any combination thereof; and Element 14: wherein the process relates to the production, refining, manufacture, formulation, blending, and/or storage of chemicals.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

To facilitate a better understanding of the embodiments of the present invention, the following examples of preferred or representative embodiments are given. In no way should the following examples be read to limit, or to define, the scope of the invention.

### EXAMPLES

The methods described herein were applied to build models relating to a distillation process to estimate the amount of butane contamination in the bottoms fraction consisting primarily of pentane. Data collected from a 40-day distillation process was used. The cleaned data included 29 variables. A cross correlation matrix analysis in the variable selection step reduced the potentially impactful variable to 17. Statistical variable reduction was then use to reduce the variable list to 14. The 14 variables were ranked with a latent variable analysis, where the variable with the highest latent variability was ranked highest and used in all models. The inferential model parameters included limiting the variable to be 7 to 10 total and requiring inclusion of the highest ranked variable. Building produced 4719 different models. To reduce computing time, all models with more than 8 variables were rejected. Further, all models with an R² of less than 0.55 or an average error greater than 5 were rejected. This resulted in several models from which a user could implement other decision parameters for selecting which model to implement in the distillation process.

In another example, methods described herein were applied to build models relating to the production of an ethylene-propylene copolymer. More specifically, the model was developed to predict (a) an amount of ethylene in the ethylene-propylene copolymer and (b) the relative ratio of gas phase polymer to slurry phase polymer. Data collected from a reactor was used including, but not limited to, reactor pressures, reactor temperatures (e.g., bed temperature and vapor temperature), reactor dew point, monomer flow rates, monomer flow rate ratios, and bed height. In this example, a total of 40 candidate variables were used. Two models were identified with R² values of 0.9 or greater.

In another example, methods described herein were applied to build models relating to fluidic catalytic cracker (FCC) fractionation and, more specifically, the API gravity of the high aromatic fuel oil. In this example, the FCC fractionation unit relied on laboratory measurement of API gravity before making adjustments to the conditions of the FCC fractionation unit to optimize the API gravity to a level that allows the high aromatic fuel oil to be sold as carbon black, which is a higher value application than fuel oil and governed primarily by the value of the API gravity. The methods described herein were applied to produce a model that would estimate API gravity of the high aromatic fuel oil based on variables that included reactor temperature, shed temperature, high aromatic fuel oil draw and feed rates, riser top temperature, and feed quality (e.g., a measured by analysis of the FTIR of the feed). The produced model allows for real-time estimation of API gravity and adjustments of the FCC fractionation unit to optimize the API gravity.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A method comprising:
receiving data relating to a process;
cleaning the data to yield cleaned data, wherein cleaning the data comprises:
identifying and removing outlying data points from the data; and
conditioning the data;
identifying inferential model parameters comprising a parameter selected from the group consisting of: a compositional property of the process as a model output that is not part of the data, operational constraints of the process, interactions between process variables of the process, and any combination thereof;
building one or more inferential models based on the cleaned data and the inferential model parameters, wherein building comprises:
identifying input variables from the cleaned data;
fitting the input variables from a first portion of the cleaned data to a model;
validating the model using a second portion of the cleaned data to yield a validation metric corresponding to the model; and
outputting the one or more models and the corresponding validation metric.

2. The method of claim 1 further comprising:
selecting a preferred model from the one or more models based on the corresponding validation metric.

3. The method of claim 2 further comprising:
implementing the preferred model relative to the process or a related process.

4. The method of claim 1, wherein the one or more models is one model, and wherein the method further comprises:
implementing the one model relative to the process or a related process.

5. The method of claim 1, wherein the data is selected from the group consisting of: upstream data, process data, downstream data, and any combination thereof.

6. The method of claim 1, wherein the identifying of the outlying data points comprises a method selected from the group consisting of: slicing methods, conditional methods, statistical methods, and any combination thereof.

7. The method of claim 1, wherein the conditioning of the data comprises a method selected from the group consisting of: synchronizing variables, noise filtering, and the like, and any combination thereof.

8. The method of claim 1, wherein the compositional property is selected from the group consisting of: concentration of a component in the composition, flash point, freezing point, boiling point, cloud point, melt flow index, density, and any combination thereof.

9. The method of claim 1, wherein operational constraints comprise a constraint of an operation parameter selected from the group consisting of: temperature, pressure, pressure compensated temperature, chemical species concentration, feed quality, contaminant concentrations, bed height, density, specific gravity, API gravity, draw rate, feed rate, flow rate, space velocity, and any combination thereof.

10. The method of claim 1, wherein the interactions between process variables comprise an interaction selected from the group consisting of: reaction rates, heat balance, correlations between temperature and pressure, operational parameter deltas, operational parameter ratios, and any combination thereof.

11. The method of claim 1, wherein the input variables comprise a variable selected from the group consisting of: temperature, pressure, pressure compensated temperature, chemical species concentration, feed quality, contaminant concentrations, bed height, density, specific gravity, API gravity, draw rate, feed rate, flow rate, space velocity, and the like, and any combination thereof.

12. The method of claim 1, wherein the identifying the input variables include a method selected from the group consisting of: cross correlation matrix methods, relief ranking methods, statistical variable reduction methods, latent variable methods, and any combination thereof.

13. The method of claim 1, wherein the models are selected from the group consisting of: neural networks, decision trees/random forest methods, kernal methods, reinforcement learning methods, and any ensemble thereof.

14. The method of claim 1, wherein the validation metric comprises a metric selected from the group consisting of: average R², look ahead R², average error, standard deviation of error, number of data points, and any combination thereof.

15. The method of claim 1, wherein the process relates to the production, refining, manufacture, formulation, blending, and/or storage of chemicals.

16. A system comprising:
a processor;
a memory coupled to the processor; and
instructions provided to the memory, wherein the instructions are executable by the processor to perform the method comprising:
receiving data relating to a process;
cleaning the data to yield cleaned data, wherein cleaning the data comprises:
identifying and removing outlying data points from the data; and
conditioning the data;
identifying inferential model parameters comprising a parameter selected from the group consisting of: a compositional property of the process as a model output that is not part of the data, operational constraints of the process, interactions between process variables of the process, and any combination thereof;
building one or more inferential models based on the cleaned data and the inferential model parameters, wherein building comprises:
identifying input variables from the cleaned data;
fitting the input variables from a first portion of the cleaned data to a model;
validating the model using a second portion of the cleaned data to yield a validation metric corresponding to the model; and
outputting the one or more models and the corresponding validation metric.
